(19) United States
(12) Patent Application Publication
(10) Pub. No.: US 2011/0097141 A1
(43) Pub. Date: Apr. 28, 2011

(54) CONNECTOR FOR USE IN MULTIPLE CONFIGURATIONS

(75) Inventor: Dennis B. Brown, Logan, UT (US)

(73) Assignee: AQUAMIRA TECHNOLOGIES, INC., Bellingham, WA (US)

(21) Appl. No.: 12/605,006

(22) Filed: Oct. 23, 2009

(51) Int. Cl. F16D 1/00; F16B 7/00; F16B 21/00

(52) U.S. Cl. 403/286; 403/292; 403/327

(57) ABSTRACT

A quick connect connector has a male member that can be changed from a first length for connection to a first female coupling member like a Camelbak female coupling member to a second length for connection to a second female coupling member like a CPC coupling member. The female coupling member of an inter-connector is configured to have independently operable buttons each moving a lip from a locked position at rest to an unlocked position to lock and unlock the male member in the female coupling member. The male member and the female member may also each be configured with a spring loaded valve that opens when the male member is inserted into the female coupling member and that closes upon removal of the male member from the female coupling member.

### BACKGROUND OF THE INVENTION

1. The Field of the Invention

This invention relates to connectors used in hydration systems for connection to receptacles of different sizes and more particularly to a male connector that can be used in multiple configurations to connect with female coupling devices of different sizes from different personal hydration systems as well as other components and accessories of various hydration systems.

2. The Relevant Technology

Personal hydration systems typically include a reservoir with an inlet to receive a charge of liquid and an outlet to communicate the liquid from the reservoir to the user typically through some form of removable discharge structure like a bite valve or an open-closed discharge valve. For example, U.S. Pat. No. 7,073,688 (Choi, et al.) shows a reservoir 12 with an inlet 20 to receive liquid and a discharge 30 for liquid to proceed through a tube 34 to a mouthpiece 42. Choi, et al. also shows and describes a number of connectors (e.g., Col. 7, line 11 to Col. 8, line 56) for interconnecting various components including connectors termed or deemed to be a quick connect assembly 70 in FIGS. 53-55 of Choi, et al. that involve a male member sized and shaped to insert into a female connectors. The “quick” connect feature comes from the fact that the connection is made by a shoving motion urging two parts together as opposed to the use of threaded devices or barbed tube connectors that typically require cutting the tubing to remove or disconnect. It is believed that the connectors of Choi, et al. are offered by Camelbak Products, LLC of Petaluma, Calif. (“Camelbak”).

FIG. 1 shows a female coupling member 10 and a connecter 12 that is sometimes called a “quick connect” that are both offered by Camelbak. The female coupling member 10 of FIG. 1 has a valve 14 that is operable between and an “on” position by which liquids may flow through the valve 14 and an “off” position (shown) in which the flow of liquids through the valve 14 are inhibited. The female coupling member 10 has a barb connector 16 for connection to suitable plastic tubing that is used in hydration systems of the type disclosed in Choi, et al. The female coupling member 10 also has a female coupling section 18 that is sized to receive the male member 20 of the connector 12. That is, the male member 20 has a length 22 and diameter 24 selected to snuggly and sealingly fit into an aperture (not shown) formed in the female coupling section 18. The male member 12 has an o-ring 26 positioned proximate its distal end 28 to effect a seal within the aperture of the female coupling section 18. The male member 12 also has a shoulder or ledge 30 extending about its perimeter to abut portions of a locking member or lever 32 in the female coupling section 18. The locking member or lever 32 is operable from a locked position in which a first portion extends toward the body 34 of the male member 12 so that the shoulder or ledge 30 are engaged by the first portion of the locking member. In turn, the male member 12 is held in the female coupling member 10 securely. However, the single locking member or lever 32 is movable from its locked to its unlocked position by the user deliberately or by accident should the locking member 32 be accidentally hooked or bumped.

The prior art connector 12 of FIG. 1 also has a separate connector 36 extending way from a center disc 38. It has a plurality of raised rings 40 sized to frictionally receive a suitably sized hose (not shown) for connection to other components of a hydration system. FIG. 2 shows an alternately configured connector 42 having a male member 44 virtually the same as male member 20. The male member 44 has a length 46 and a diameter 48 essentially the same as length 22 and diameter 24 of the male member 20. The male member 46 can thus be removably and sealingly inserted into the female coupling section 18 the same as male member 20. The alternately configured connector 42 has a cylindrical separate connector 50 sized to receive a suitable elastically deformable tube (not shown) there over.

While different brands of products may use connectors of different configurations and sizes, two types of connectors are in widespread use for connecting a personal hydration system to tubing, filters, refill devices, or any other component of or accessory used with a personal hydration system. The first type is manufactured by Camelbak Products, LLC of Petaluma, Calif. and is shown in FIGS. 1 and 2. The second type is made by Colder Products Company (“CPC”) of St. Paul, Minn. and is disclosed in U.S. Pat. No. 6,231,089 (Decler, et al.). Referring to FIG. 3, a CPC structure includes a female coupling member 52 and a quick connect connector 54. The female coupling member 52 has a receiving chamber 56 sized to sealingly receive the male member 58 of the quick connect 54. The male member 58 has a length 62 and a diameter 64 selected so that it can be inserted into the chamber 58 and locked in place by a lever lock 60 that moves between a locked position and an unlocked position. The male member has an ‘o’ ring 66 to effect the sealing connection in the chamber 58 and a shoulder or ledge 68 to interact with the lever lock 60 which can be opened manually or accidentally by accidentally hooking it on something. The connector 54 also has a disc 70 centrally disposed for grasping by the user and for centering the connector 54 in the opening of the receiving coupler. The connector 54 also has a barb connector 72 for connection to other components of a hydration system.

Notably, both types or versions of connectors 12 and 54 are configured differently. Specifically, the male member 20 (FIG. 1) and the male member 58 (FIG. 3) each have a different length 22 and 62 respectively. While essentially of the same diameter 24 and 64, the male members cannot effect a suitable connection with both female coupling members 10 and 52 because they have different lengths and the receiving chambers like chamber 54 are of different lengths. Notwithstanding widespread use of the first connector by a large distributor of hydration systems and widespread use of the second connector by other manufacturers, the hydration products of the two manufacturers cannot be used with each other because they are mechanically incompatible. As a result, it is not possible or very difficult to transfer liquid between a hydration system having connectors the first type connector with a hydration system having the second type connector.

A connector that can be configured for use with the first type and the second type and that, in turn, can be reliably connected to systems and components of other manufactures is not known. That is, a so-called “universal” “quick-connect” connector arrangement for connecting to differently sized female coupling members of different types or sizes has been heretofore unknown. In addition, a suitable female coupling member or inter-connector for effecting a reliable and safe locked connection to other hydration components has also been unknown.

### SUMMARY OF THE INVENTION

A spacer is sized for use with, or is part of, a connector having a male member that has a distal or first end for connecting to or with a first female coupling member and for connecting to or with a second female coupling different in size from the first female coupling member. The spacer is sized to change the length of the male member between a first length for connecting to or with the first female coupling member with the spacer removed from the male member and a second length for connecting to or with the second female coupling member with the spacer installed on the male member. Preferably, the spacer has an aperture formed therein sized to receive the first end of the male member there through. Alternately, the spacer may also be formed in two parts or halves that mate together about the male member. In yet another alternate, the spacer may be “C” shaped with a slot so that it can fit over and onto the male member.

The spacer is preferably made of a resilient or a compressible material. A suitable polymer or rubber-like material is typical. Preferably, the spacer is shaped as a truncated cone or substantially so. But it may be in other geometrical shapes as discussed hereinafter.

Most preferably, the first end at the first length is sized to fit into a standard female coupling member of Camelbak Products, LLC; and the first end modified to the second length is sized to fit into the standard female coupling member of Colder Products Company. The invention also includes a connector that can be of the type that is referred to as a “quick” connector. It has a first end configured as a male connector for connecting with a female coupling member and a second end configured for connection to a fluid system. A center abutment member is attached to and between the first end and the second end. A channel is formed in and extends through the first end and the center abutment member to the second end for the flow of fluid there through. The spacer hereinbefore discussed is positionable on or about the first end of the connector adjacent the center abutment member to change the length of the first end between a first length with the spacer removed for connection to or with a first female coupling member sized to receive a male member of the first length and a second length with the spacer in position for connection to or with a second female coupling member sized to accept a male connecting member at the second length and not at the first length.

In preferred configurations, the first end has a first axis and the second end has a second axis. In one configuration the first axis and the second axis are coaxial. In an alternate configuration, the first axis and the second axis are at an angle.

In some desired configurations, the first end includes a valve that opens upon insertion of the first end into either or both of the second female coupling members and closes upon removal. Alternately, the female coupling member includes a valve configured for operation from a closed position to an open position upon insertion and removal of the first end into one or both of the first and second female connectors.

In some configurations the second end is a barb connector. However, it may be any desired structure needed to effect a connection with a fluid hydration system or components thereof. The second end may also be a second male member configured like the first male member with a removable spacer to change the length of the second end between a first length with the spacer removed and a second length with the spacer in position.

In preferred arrangements, the connector is configured for insertion into a female coupling member that includes a base having a channel formed therein for the movement of fluid there through. The base has a first port and a second port mechanically associated. The ports can be glued, welded, friction welded, threaded to or even unitarily formed with the base to communicate fluid there through to and from the base. The first port is configured for removable and sealing connection with a first external fluid communicating structure. Thus, it may have a barb connector, a thread arrangement, or any other configuration to effect a suitable fluid connection.

The second port has a second port aperture formed therein. The second port aperture is sized to removably and sealingly receive the first end of the connector therein with a suitable spacer attached so that the first end is configured to be at a second length. The second port has a second port connector that includes a first latch structure, second latch structure, a first button and second button. The first latch structure is movable between a first latch position and a second latch position. In the first latch position, the first latch structure is urged into the second port aperture for engaging the first end of the connector when the first end is positioned in the second port aperture. In the second latch position, the first latch structure is urged away from the first end when the first end is positioned in the second port aperture.

The second latch structure is also movable between a first latch position and a second latch position in which the second latch structure is also urged into the second port aperture for engaging the first end of the connector when the first end is positioned in the second port aperture. In the second latch position, the second latch structure is urged away from the first end of the connector when the first end is positioned in the second port aperture.

The arrangement includes a first button positioned for operation by a user to move the first latch structure between its first latch position and its second latch position. The arrangement also includes a second button positioned for operation by a user to move the second latch structure between its first latch position and its second latch position. The second button is separate from and independently operable from the first button.

The arrangement includes first biasing means positioned proximate the first button to urge the first button and, in turn, the first latch structure toward its first latch position and second biasing means positioned proximate the second button to urge the second button and the second latch structure toward its first latch position. In preferred configurations, the first latch structure includes a first lip positioned to engage the first end of the connector when it is the second port aperture. The second latch structure also includes a second lip positioned to engage the first end of the connector when the first end is in the second port aperture. The inventions herein also include a female coupling member as outlined above in which the buttons are separate and independently operable. Thus, to remove the connector in the second port aperture, both buttons must be operated (depressed by the user) to urge both the first lip and second lip away so that the first end of the connector can be pulled out of or from the second port aperture.

In preferred arrangements, the second port of the female coupling member or connector is cylindrical in shape with an exterior surface. The second port aperture is also cylindrical in shape and sized to receive the first end of the connector therein.

In a useful alternate, a first fulcrum attached to the exterior surface. The button is positioned to rotate about the fulcrum thereby defining a first portion of the first button extending on one side of the first fulcrum and a second portion of the first button extending on the other side of the first fulcrum. A first lever arm is attached to the first portion and is sized to cause the first lip to move inwardly and outwardly between the first latch position and the second latch position as the second portion of the first button moves inward and outward toward and away from the exterior surface of the second port. The first biasing means includes a first resilient lever and a second resilient lever or arm spaced from each other with both extending outwardly from the lower portion of the second portion of the first button and toward the exterior surface of the second port. The first resilient lever and the second resilient lever are both sized to contact the exterior surface and elastically deform about the exterior surface as the second portion of the first button moves inward. In turn, the first and second resilient levers want to return to their static condition and urge the second portion of the first button outwardly from the exterior surface. In turn, the first latching structure is urged back to its first latch position. The second button is similarly configured.

In an alternate and highly preferred configuration, the first latch structure includes a first arm that extends around the second port aperture to position the first lip generally opposite the first button. Similarly, the second latch structure includes a second arm that extends around the second port aperture to position the second lip generally opposite the second button. The first biasing means is a first resilient member positioned between the first button and the exterior surface of the second port. The first biasing means is configured to urge the first button and the first lip toward its first latch position to hold the first end or male member of a connector in the second port aperture. The first biasing means is compressible upon movement of the first button toward the exterior surface by a user to urge the first latch structure including its first lip toward its second latch position away from any first end or male connector in the second port aperture. The second biasing means is a second resilient member similarly positioned between the second button and the exterior surface of the second port. The second biasing means is configured to urge the second button and the second lip toward its first latch position. Upon movement of the second button toward the exterior surface by a user, the second biasing means is compressed and the user urges the second latch structure including its second lip away from any male member in the second port aperture. In turn, the user must depress both the first button and the second button to remove any male member in the second port aperture.

In alternate configurations, the first port may be a barb connector or a threaded connector. In yet other configurations, the male member includes a valve that opens upon insertion of the male member into the second port aperture and closes upon removal of the male member from the second port aperture. Also, second port aperture may include a valve configured for operation from a closed position to an open position as a male member is moves into the second port aperture.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is an exploded perspective view of one type of prior art connector with a prior art male member and a prior art female connector;

FIG. 2 is a perspective view of a prior art connector for use with the prior art female connector of FIG. 1;

FIG. 3 is an exploded perspective view of another type of prior art connector with a prior art female connector;

FIG. 4 is a perspective exploded view of a universal connector and an inter-connector of the present invention;

FIG. 5 is another perspective exploded view of a universal connector and a coupling member or inter-connector of the present invention;

FIG. 6 is a perspective view of a universal connector and a coupling member or inter-connector of FIG. 4 assembled;

FIG. 7 is another perspective view of a universal connector and a coupling member or an inter-connector of FIG. 5 assembled;

FIG. 8 is an exploded view of the universal quick connect of FIGS. 4-7 with a spacer of the invention;

FIG. 9 is an exploded perspective view of a female coupling member of the present invention;

FIG. 10 is an exploded perspective view of a female coupling member of FIG. 9;

FIG. 11 is an exploded perspective view of an alternate and highly preferred female coupling member of the invention;

FIG. 12 is a view of one end of a female coupling member of FIG. 9;

FIG. 13 is a perspective view of an alternate inter-connector similar to the inter-connector of FIG. 11;

FIG. 14 is perspective view of a button and arm for use in the female coupling member of FIGS. 11 and 13;

FIG. 15 is a perspective view of a spring for use in the female coupling member of FIGS. 11 and 13;

FIGS. 16 and 17 are cross-sectional views of an alternate female coupling member of the invention;

FIG. 18 is a cross-sectional view of an alternate female coupling member of the invention;

FIG. 19 is an alternate female coupling member of the invention;

FIG. 20 is a perspective view of a quick-connect connector of the invention having two male members with an alternate configuration in phantom;

FIG. 21 is a cross sectional view of a quick connect connector and an inter-connector with the female coupling member of the inter-connector having a valve associated therewith;

FIG. 22 is a perspective view of a bobbin for use in the female coupling member of FIG. 21;

FIG. 23 is a cross sectional view of a quick connect connector and an inter-connector with the male member of the quick connect connector having a valve associated therewith;

FIG. 24 is a perspective view of a quick connect connector similar to that of FIG. 8 with an alternate spacer associated therewith; and

FIG. 25 is a perspective view of a quick connect connector similar to that of FIG. 8 with another alternate spacer associate therewith.

### DETAILED DESCRIPTION OF THE PREFERRED EMBODIMENTS

In reference to the drawings, exemplary embodiments of the invention are illustrated and described hereinafter. It is to be understood that the drawings are diagrammatic and schematic representations of such exemplary embodiments, and are not drawn to scale but intended to illustrate features and functions. They are not intended to be limiting of the present invention.

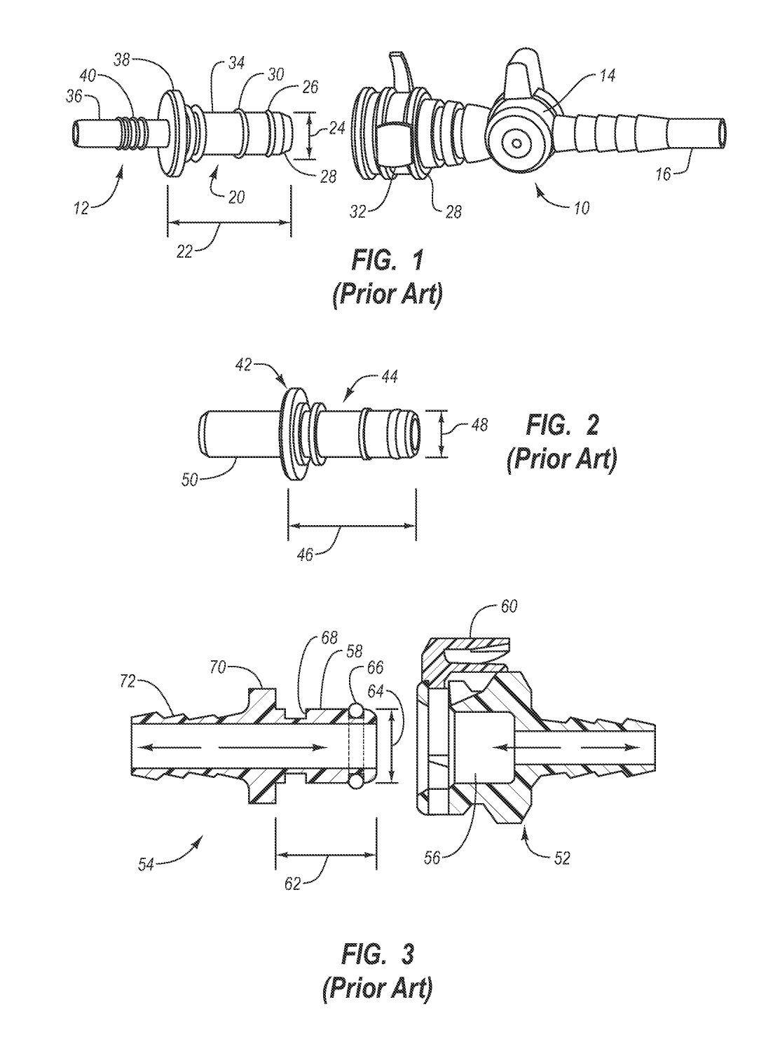

In reference to FIGS. 1 and 2, a first type of prior art connection arrangement has a female coupling member 10 and a connecter or male member 12 or 42 that are of the type sometimes called a “quick connect” because they are both fairly easy to operate and involve a simple push-together motion to effect a connection. Both are offered by Camelbak as hereinbefore discussed. A second type of prior art connection arrangement is made by CPC and is shown in FIG. 3. The CPC® structure includes a female coupling member 52 and a “quick connect” connector 54 that are also joined together by a simple push together motion. In other words, more complicated connection arrangement like those equating, for example, to a plumbing union or other threaded arrangements are not involved.

Notably, both types or versions of connectors 12 and 54 are configured differently. Specifically, the male member 20 (FIG. 1) and the male member 58 (FIG. 3) each are of the same diameter 24 and 64; but each have a different length 22 and 62 respectively. In turn, the male members 20 and 58 can effect a suitable connection only with its related female coupling member 10 and 52. That is, the Camelbak® male members 20 and 42 cannot fit or mate with the CPC® female coupling member 52. While it can be inserted, it is too long and, in turn, the locking mechanism will not work. Thus, the connection cannot be held together. Similarly, the CPC® connector 54 cannot fit with or mate to the Camelbak® female coupling member 10 because it is too short. The locking structure 32 is oriented so that it cannot lock the CPC® connector 54 in place so the connection cannot be held together. In short, the connectors 12, 42 and 54 can fit only one female receiving member because the male members 20, 44 and 58 have different lengths 22 and 62; and the receiving chambers like chamber 56 are of different lengths.

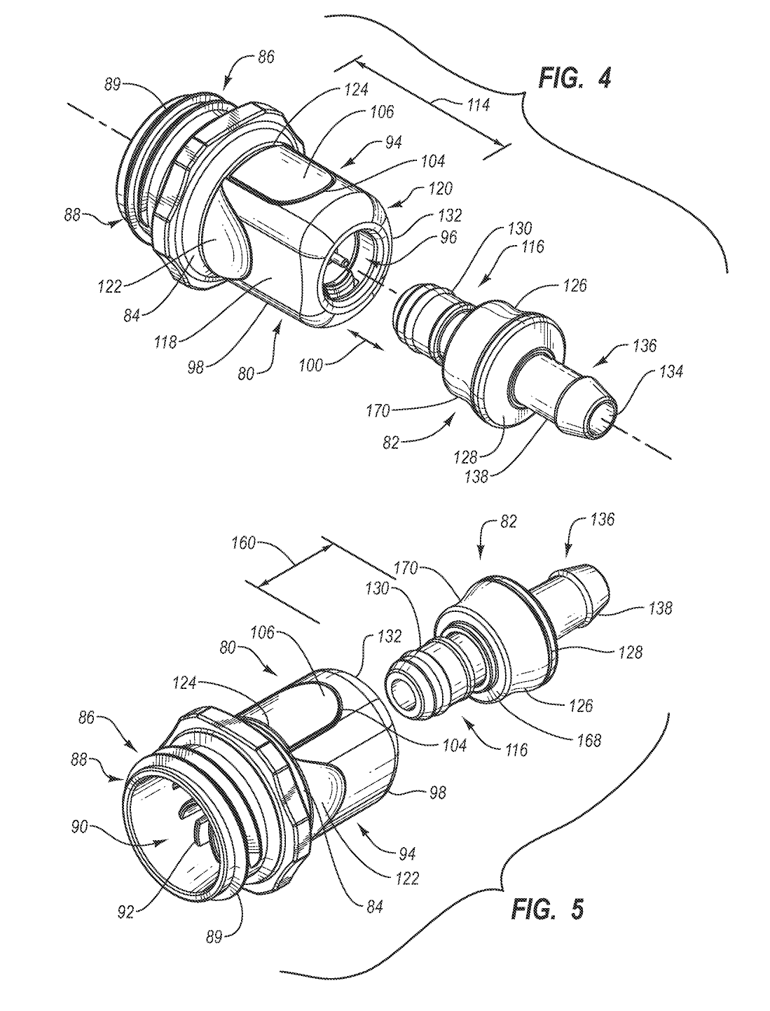

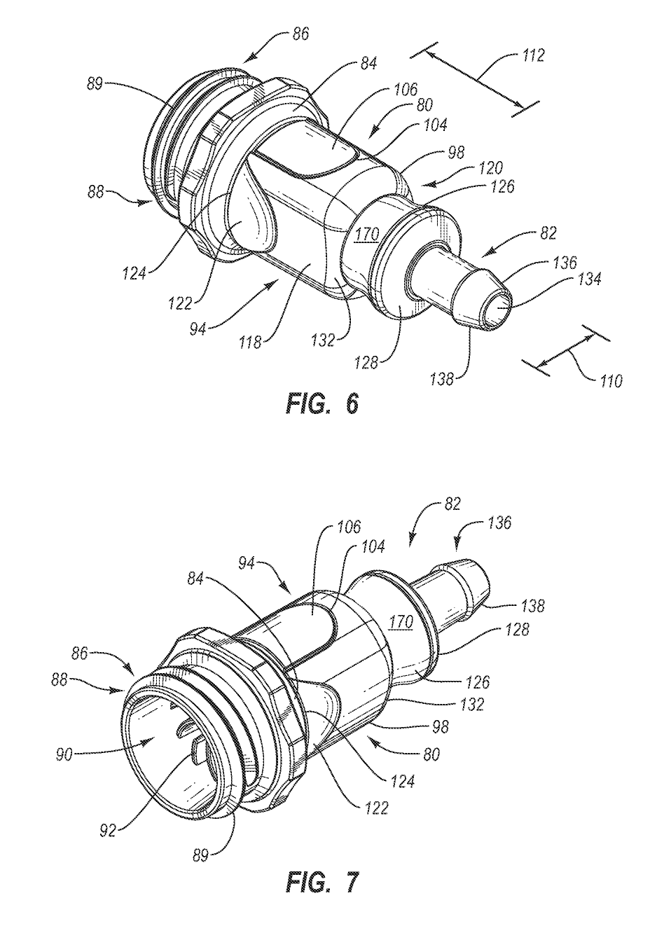

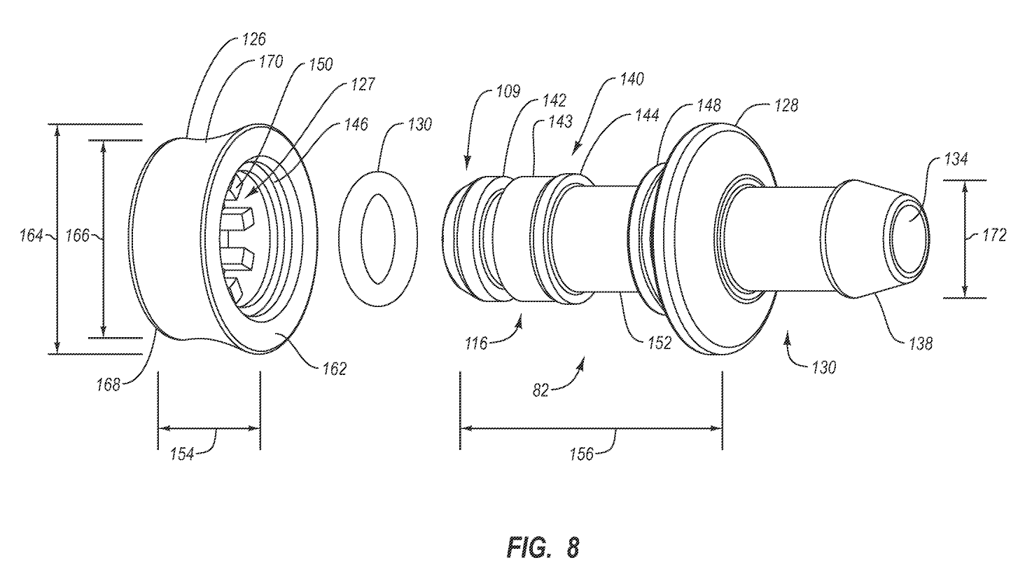

A female coupling member or inter-connector 80 is shown with a “quick-connect” type connector 82 in exploded relationship in FIGS. 4 and 5 and in an assembled relationship in FIGS. 6 and 7. The inter-connector 80 has a base 84 to which a first port 86 is attached by any suitable means including glue. With the base 84 and the first port 86 made out of a suitable plastic, various techniques for welding plastic may be used. Also, the first port 86 and the base 84 may be unitarily formed together in preferred arrangements.

The first port 86 is shown with a male thread portion 88 which is configured with male threads 89 to receive a female threaded connector to connect to any suitable threaded female connector associated with a hydration system or an accessory for use with an hydrations system. While a male thread portion 88 is shown, it should be understood that the first port 86 may have any connecting structure desired for further connection to an hydration system or other accessories for use with a personal hydration system. As shown hereinafter, the first port 86 may have, among other types or forms, a bayonet and a tubular connector.

The first port 86 includes a first port channel 90 which is in fluid communication with an aperture in the base 84. The first port 86 also includes a plurality of vanes 92 which are arcuate in shape and which distribute liquid passing through the first port 86 evenly over the surface of and support a prefilter that is not here shown.

The inter-connector 80 also has a second port 94 that has a second port aperture 96 formed therein that is shown to be cylindrically shaped. The second port aperture 96 in effect becomes a channel that extends through the second port 94 to be in communication with the aperture in the base 84 and the first port channel 90. Thus, liquids may flow between the first port channel 90 and the second port aperture 96 of the second port 94. The second port 94 is connected to the base 84 by any suitable means including glue and using plastic welding techniques. In preferable arrangements, the base 84 and the second port 94 are unitarily formed. The jacket 98 of the second port 94 is typically fixedly installed but it may also be made to be removable because it could be configured to be slid away from the base 84 and back on the base 100 along or in the direction of the axis 102. The jacket 98 is formed with an opening 104 sized to receive a first button 106 that is movable between it at rest position shown in FIGS. 4-7 and a depressed position as more fully discussed hereinafter. The jacket 98 is also formed with a second opening sized to receive a second button both comparable to the first opening 104 and first button 106 but opposite the first opening 104 and first button 106.

The first button 106 and the second button (not shown) of FIGS. 4-7 are shaped to be arcuate or rounded exterior surface 108 to fit with the shape of the jacket 98. The first button 106 is sized to have a width 110 (e.g., about ½ inch) and a height 112 (e.g., about ½ inch) selected to easily receive a tip or top portion of any one of the five fingers of a user which is used to press the first button 106 from its at-rest position as shown to a depressed condition discussed herein after. The first button 106 and the second button (not shown) operate independently of each other each controlling respectively first and second latching structure to latch the male member 116 of the quick connect or connector 82 shown in FIGS. 4 and 5 as more fully discussed hereinafter.

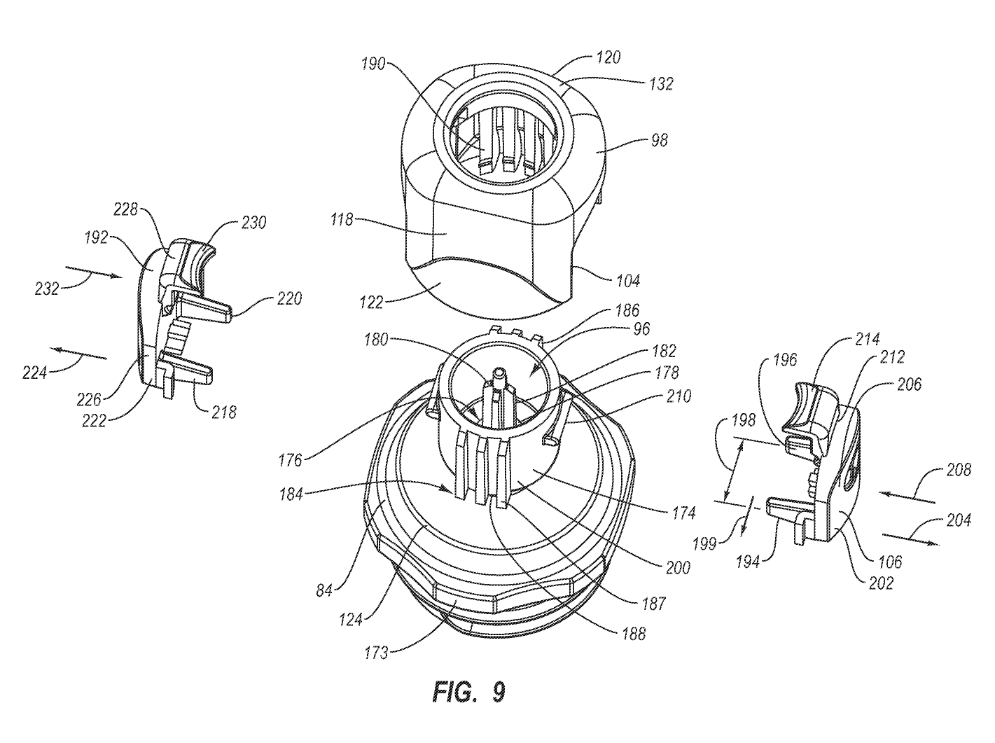

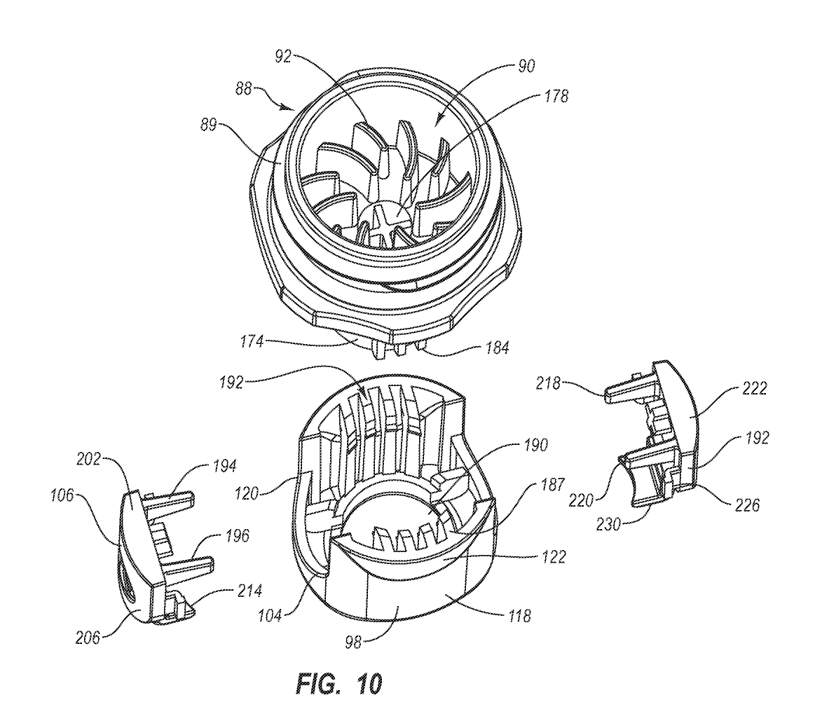

The jacket 98 in FIGS. 4-7 has a height 114 selected so that a user will have a reasonable gripping surfaces 118 and 120 that are opposite each other. The jacket 98 is not round (circular in cross section) but rather is somewhat ovular in cross section with the gripping surfaces 118 and 120 being essentially or substantially flat with a flared portion or skirt 122 to effect a smooth and finished transition to a ring 124 formed in the base 84. The user may then hold the inter-connector 80 by grasping the gripping surfaces 118 and 120 with the user's thumb and another finger like the forefinger. While holding the inter-connector 80, the male member 116 of the connector 82 may then be easily aligned along axis 102 and inserted into the second port aperture 96 to effect a secure connection there between as more fully discussed hereinafter. To effect separation, the buttons 106 and the one opposite it 192 (FIGS. 9 and 10) are depressed by the user again with a thumb and a finger like the forefinger to operate first latching structure and second latching structure which illustrated and described in connection with FIGS. 9-11. To remove or separate the, the user can grasp the connector 82 at or around the spacer 126 and the abutment member 128 with the fingers of the other hand and pull the connector 82 out of and separate it from the female coupling member or inter-connector 80.

The connector 82 of FIGS. 4-7 is shown with first end that is a male member 116 configure with an ‘o’ ring 130 sized to effect a snug and water tight seal as it is inserted into the second port aperture 96 and into the second port channel until the spacer 126 abuts against the top 132 of the jacket 98 so that fluid can flow through the channel 134 in the connector 82 and be in communication with the second port aperture 96 and through the base 84 to and with the first port channel 90. The quick connect device or connector 82 of FIGS. 4-7 is shown with a second end 136 that is here depicted as a barb connector 138 for connection with standard plastic-type tubing presently used with hydration systems.

FIG. 8 is an exploded perspective view of the connector 82 of FIGS. 4-7 showing the spacer 126 and ‘o’ ring 130 separate from the first end 140. That is, the connector 82 has a first end 140 and a second end 136 both connected to an abutment member 128. A channel 134 is formed to extend through the first end 140, the second end 136 and the abutment member 128 for the flow of fluids through the connector 82. The second end 136 is here configured as a barbed connector 138. However, it may be configured to be some other form of connector. The first end 140 is configured as the male member 116 with an ‘o’ ring groove 142 and a latch collar or shoulder 144 to abut against latching structure as hereinafter discussed to inhibit removal of the connector 82 from the female coupling member and more particularly, the second port aperture 96 of the second port 94 of the inter-connector 80. The spacer 126 has a raised ring 146 sized to fit into the groove 148 of the male member 116 to hold the spacer 126 on the male member 116 with the spacer 126 being sized to abut the abutment member 128. The spacer 126 is formed of a material that is at least compressible and typically a resilient material. It may be made of any suitable polymer, rubber or similar material that is in effect elastically deformable but nonetheless rigid enough to maintain shape as it is grasped by the user. The spacer 126 is formed so that it may be easily placed on or over the male member 116 and easily removed. That is, the spacer 126 typically elastically deforms sufficiently to pass over the ‘o’ ring and the ring 148 as it is placed on or over the male member 116 and again as it is removed from position on or over the male member 116. The spacer 126 also has ribs 150 to provide for stable placement against the throat 152 of the male member 116.

The spacer 126 of FIG. 8 is formed to have a length 154. When the spacer 126 is installed on the male member 116 with the ring 146 in the groove 148, the length of the male member 116 is changed from a first length 158 to a second length 160. That is, the sum of the second length 160 and the length 154 of the spacer 126 in substance equals the length 156 of the male member 116. In turn, the effective length of the male member 116 can be changed from the first length 156 to the second length 160 by placing the spacer 126 on or over the male member 116. It may also be noted that the spacer 126 as shown, is in the form of a truncated cone with a base 162 having a larger diameter 164 than the diameter 166 of the top 168. The side wall 170 of the spacer 126 is also concave to supply a recess for placement of the thumb and forefinger thereabout and to provide a thinner sidewall for ease in deformation when placing the spacer 126 on and taking the spacer off the male member 116. The male member 116 and the barbed connector 138 each have a main body diameter 172 that is selected for mating with a female coupling member like the second port 94 of the inter-connector 80.

FIGS. 9 and 10 are exploded views of the connector 82 of FIGS. 4-7. The base 84 is shown with a faceted ring 173 so the user can more easily grasp the base 84 when installing a female threaded connector onto the first port 86. With the jacket 98 removed from the base 84 an internal conduit 174 is seen that may be separately formed and attached to the base 84 using glue, various plastic welding techniques or any other process or structure to securely and sealingly attached them together. Alternately, and as illustrated, the internal conduit 174 is unitarily formed with the base 84. As depicted, the internal conduit 174 is cylindrical in shape with the second port aperture 96 formed to define the opening to the second port channel 176 that extends to and is in communication with the channel 178 formed in the base 84. A bobbin 180 is positioned in the second port channel 176 to assist with alignment and to act as a guide for the male member 116 (FIG. 8) as it enters and is urged into the second port channel 176. The bobbin 180 also interacts with a bobbin member of a valved male connector to open the valve member in the male connector when connected as hereinafter discussed. Notably, the bobbin 180 has wall members 182 in an ‘X’ configuration to provide structure to align the channel 134 of the connector 82 and to allow space for liquid to flow through or past the bobbin 180.

The internal conduit 174 as depicted has two sets of outside stiffeners 184 and 186 opposite to each other each having separate rails 187 to form multiple tracks or gaps 188 as best seen in the set of stiffeners 184. A set of stiffeners 190 and 192 each are positioned or formed on the inside of the jacket 98 each of which mate with or slide into the gaps 188 and the gaps not seen in the stiffeners 186. As a result, the jacket 98 is stably positioned about the internal conduit 174.

FIGS. 9 and 10 also show the first button 106 and the second button 192 which is positioned opposite the first button 106. The first button 106 has a first arm or first member 194 and a second arm or second member 196 that are spaced apart a distance 198. The first member 194 and the second member 196 are both made of a plastic and unitarily formed with the first button 106. They are elastically deformable and, in turn, act as springs. When the first button 106 is installed and the jacket 98 is positioned as seen in FIGS. 4-7, the first member 194 and the second member 196 are pushed apart or outwardly 199 as they come in contact with the outer surface 200 of the internal conduit 174. In turn, the first member 194 and the second member 196 generate a force to bring the first member 194 and the second member 196 inward and, in turn, are pushing the bottom portion 202 of the button outward 204. In turn, the upper portion 206 of the first button 106 rotates inwardly 208 about the fulcrum 210 that is attached to the outer surface 200 of the internal conduit 174. In turn, a lever arm 212 extending upwardly from the first button 106 moves inwardly along with a lip 214 which is attached to the lever arm 212. Thus, the lip 214 is urged toward the male member 116 when it is inserted into the second port aperture 96 and into the second port channel 176. As the male member 116 moves into the second port channel, the sleeve 143 moves past the lip 214 which is then urged inwardly toward the male member 116. In turn, the latch collar or shoulder 144 (FIG. 8) will engage the lip 214 when the male member 116 is urged out of the second port channel so that the male member 116 is held in the second port channel 176 by lip 214.

In a similar fashion, the second button 192 has members 218 and 220 that also creates a spring force to urge the lower portion 222 of the second button 192 outward 224. In turn, the upper portion 226 and, in turn, the lever arm 228 and lip 230 are urged inward 232 so that the lip 230 engage the latch collar or shoulder 144 (FIG. 8) when the male member 116 is inserted into the second port channel 176. As a result, it can be seen that to remove the male member 116, both the first button 106 and the second button 192 must be pressed to urge their respective bottom portions 202 and 222 inward and to, in turn, cause the upper portions 206 and 226 to move outwardly so their respective lips 214 and 230 are moved away from engagement with the latch collar or shoulder 144. Thus, the male member 116 is safely held in a locked position. The male member 116 cannot be accidentally removed or dislodged when after it has been inserted and locked into position by the lips 214 and 230. The risk of loss of liquid by virtue of accidental dislodgement is thus reduced.

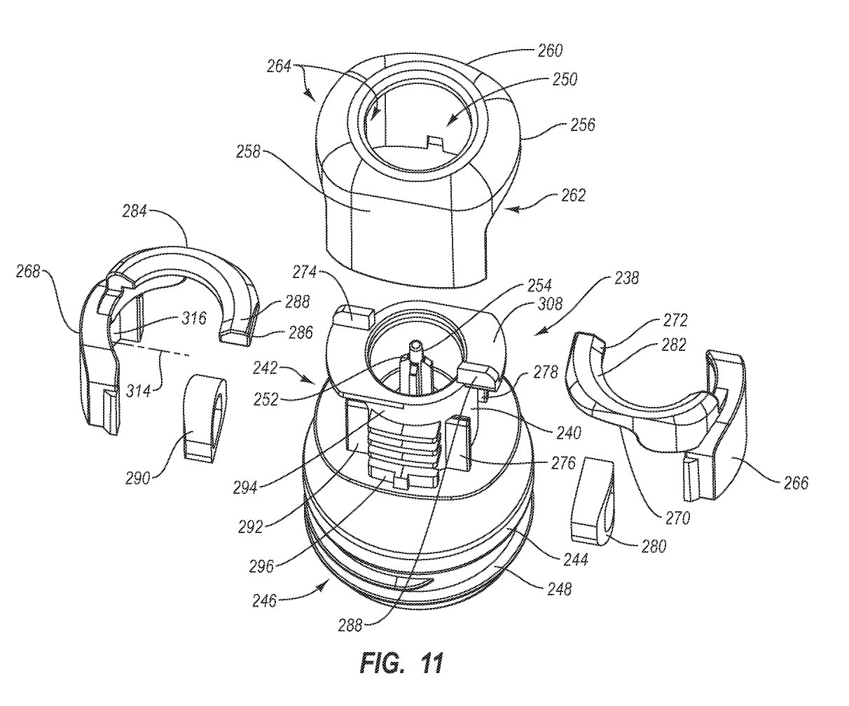

FIG. 11 shows an alternate and highly preferred configuration of a female coupling member as part of an inter-connector 238 in which the internal conduit 240 of the second port 242 is attached to the base 244 by glue, plastic welding techniques or the like. Preferably, the internal conduit 240 is unitarily formed with the base 244. A first port 246 is also affixed to base 244 much like the first port 86 is attached to base 84 in FIGS. 9 and 10. The first port 246 is shown with male threads 248 in a fashion similar to male thread portion 88 in FIGS. 4, 5, 9 and 10.

The inter-connector 238 of FIG. 11 has a second port aperture 250 with a second port channel 252 that is sized to receive the male member 116 the same as second port channel 176 of FIGS. 9 and 10. The second port channel 176 also has a centering bobbin 254 that is comparable to bobbin 180 of FIG. 9. The second port 242 also has a jacket 256 that is formed comparable to jacket 98 with two substantially opposite flat gripping surfaces 258 and 260 and two openings 262 and 264. The two openings 262 and 264 are substantially the same and opposite other; and they are respectively sized to receive a first button 266 and a second button 268. The first button 266 and the second button 268 are part of latching structure that moves between a latched position in which the male member 116 is held in the second port channel 252 and an unlatched position in which the male member 116 may be removed from the second port channel 252.

The first button 266 and the second button 268 move in their respective openings 282 and 264. A first arm 270 is attached to and here unitarily formed with the button 266. The first arm 270 extends from the button around the aperture 250 inside the jacket 256 and is sized so that the distal end 272 of the first arm 270 abuts the stop 274. The first arm 270 is arcuate and sized so it does not extend into the aperture 250 in its first position. That is, the first arm 270 is part of the latching structure and moves between a first position to latch or hold the male member 116 in the second port channel 252 and a second position in which the male member 116 may be removed. The first button 266 is sized to fit over or to receive two uprights 276 and 278. The uprights 276 and 278 align the first button and retain in between a resilient biasing means to urge the first button 266 and, in turn, the first arm to their first positions. The resilient biasing means is here shown as a silicon spring 260 which is an ovular piece of silicon that is elastically deformable and, in turn, operates as or functions as a spring. The silicon spring 260 is sized to fit between the uprights 278 and 276. That is, the silicon spring 260 may be a piece of a suitably sized silicon tubing of a desired diameter and cut or molded to fit. In turn, the first button 266 is urged outwardly toward an at-rest position comparable to first button 106 shown in FIGS. 4-7. In turn, the first arm 270 is urged inwardly toward the male member 116 to function as a first lip 282 when it is positioned in the second port channel 252. That is, the first lip 282 is urged toward the throat 152 (FIG. 8); and, in turn, the first lip 282 is in position to engage the shoulder 144 of the male member 116 if and as the male member 116 is urged out of the second port channel 252. Thus, the male member 116 is inhibited from movement out of the second port channel 252.

Similar to the first button 266, the second button 268 has a second arm 284 that extends around the aperture 250 inside the jacket 256. The second arm 284 has a distal end 286 that abuts the stop 287. The second button 268 is sized to fit in and move in the button opening 264 between a first position and a second position. In the first position, the arm 284 extends around the aperture 250 with a distal portion 286 thereof that functions as a second lip 288 extending into the aperture 250 to engage the shoulder 144 of the male member 116 (FIG. 8). Upon applying force to the second button 268 to move it inward, it and the second lip 288 move to the second position in which the second lip 288 is removed from the aperture 250 so that it does not inhibit removal of the male member 116 from the second port channel 252. The second button 268 and the second arm 284 are part the latch structure that moves between a first latch position and second latch position as hereinbefore discussed.

FIG. 11 shows a second biasing means as a silicon spring 290 comparable to the silicon spring 260. The silicon spring 290 is positioned between uprights like upright 292 to center the second button 268 and retain the silicon spring 290 in place. When the first button 266 and the second button 268 are depressed or pushed inwardly toward the internal conduit 240, the springs 280 and 290 are compressed. When buttons 266 and 268 are depressed, the first lip 282 and the second lip 288 are both urged outwardly from the aperture 250 so that a male member 116 of a connector like connector 82 may be removed.

The internal conduit 240 of FIG. 11 also has an external surface 294 with one set of ribs 296 on one side and a second comparable set of ribs on the other side that cannot be seen in FIG. 11. The set of ribs 294 and the second set (not shown) extend outwardly to support the gripping surface 258 and gripping surface 260 when the jacket 256 is positioned over and about the internal conduit 240.

While resilient biasing means urging the buttons has been shown as silicon springs 280 and 290, it should be understood that other forms of elastically deformable material may be used. For example the spring means for use with the first button 266 and the second button 268 may be suitably sized coil springs and leaf springs.

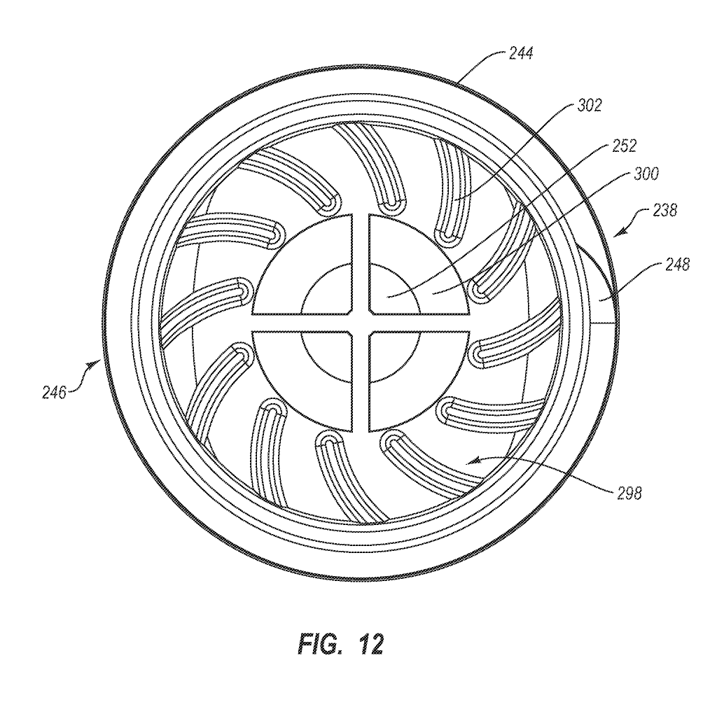

FIG. 12 illustrates the first port 246 of the inter-connector 238 of FIG. 11. The first port 246 has a first port channel 298 that communicates through the base channel 300 to the second port channel 252. A plurality of vanes 302 are shown in the first port 246 to direct fluid over and to support a prefilter that is not here shown.

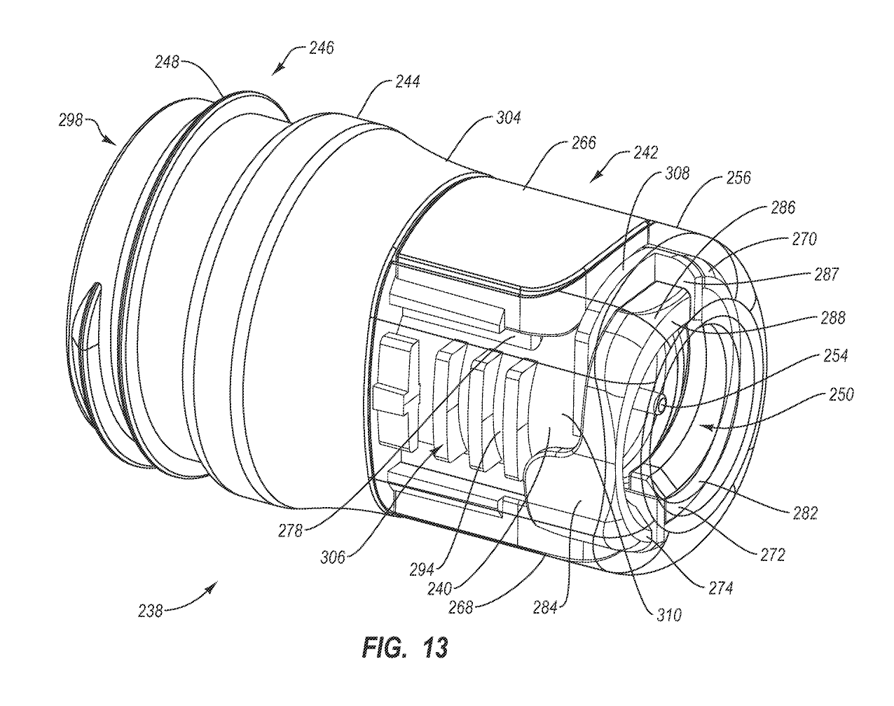

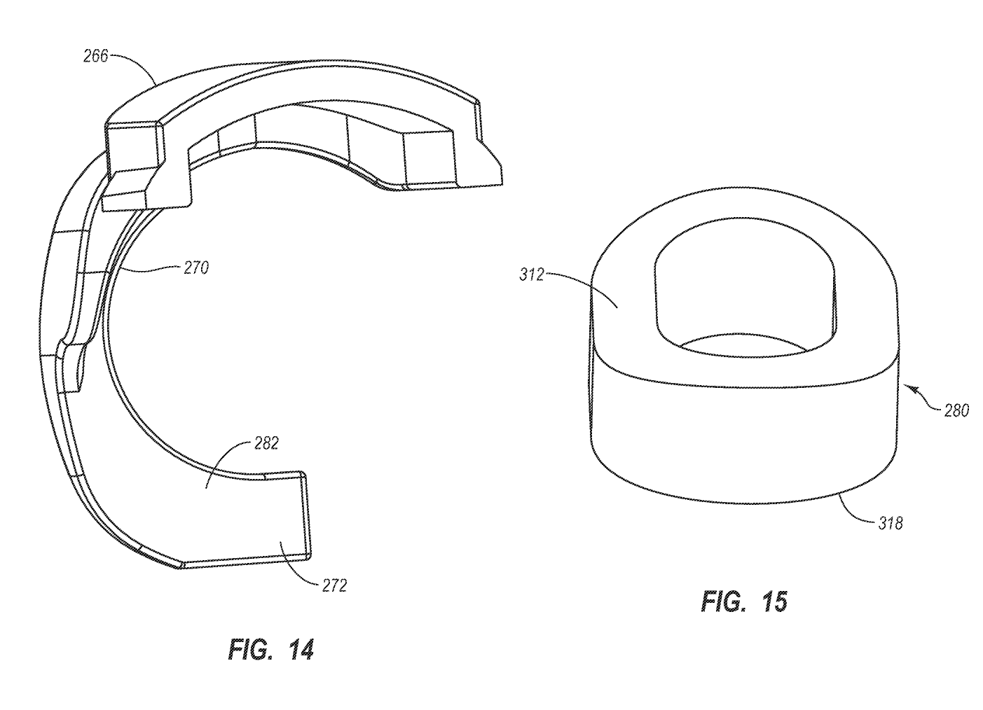

FIG. 13 depicts the inter-connector 238 of FIG. 11 assembled with the base 244 having a skirt portion 304 shaped to make smooth transition to the jacket 256 which is here shown in part in phantom so that the internal conduit 240 can be seen with the second set of ribs 306 now visible. Further, the arms 270 and 284 can be seen placed on and moving on support plate 308 that is on the distal end 310 of the internal conduit 240. FIG. 14 is an enlarged view of the first arm 270 and first button 266 of the second port 242 or female coupling member of the inter connector 238 of FIGS. 11 and 13. FIG. 15 is an enlarged view of the silicon springs 280 and 290. It can be seen that the outer surface 312 is slightly rounded to match the radius 314 of the inner surface 316 of second button 268 and a similar inner surface of the first button 266. The inner surface 318 of the silicon springs 280 and 290 are also rounded to fit snuggly against the outer surface 294 of the internal conduit 240 that is generally cylindrical in shape as best shown in FIG. 11.

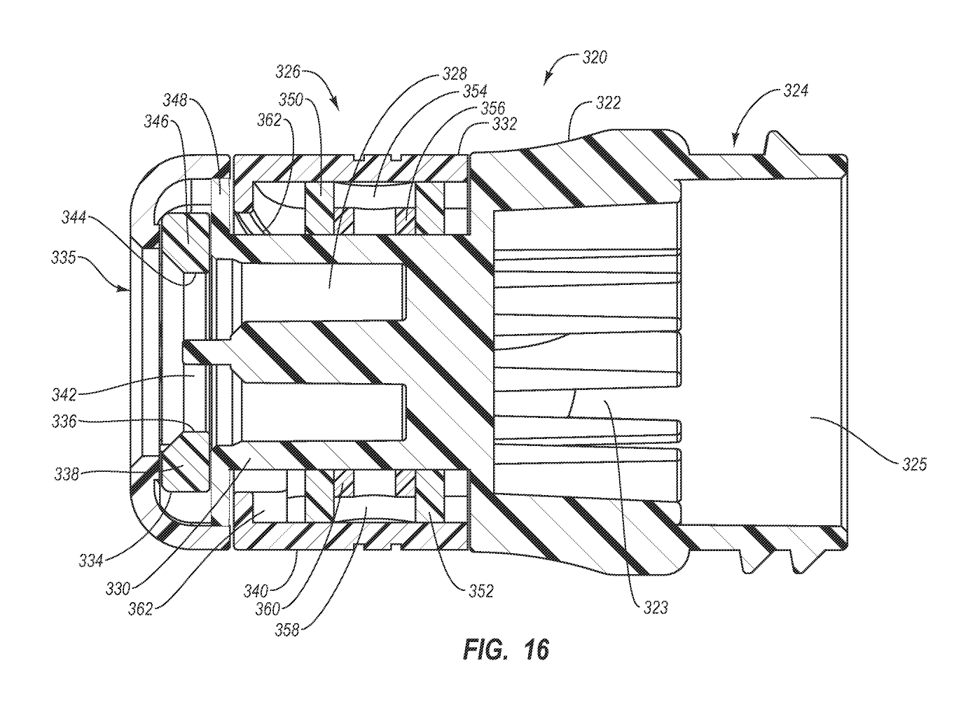

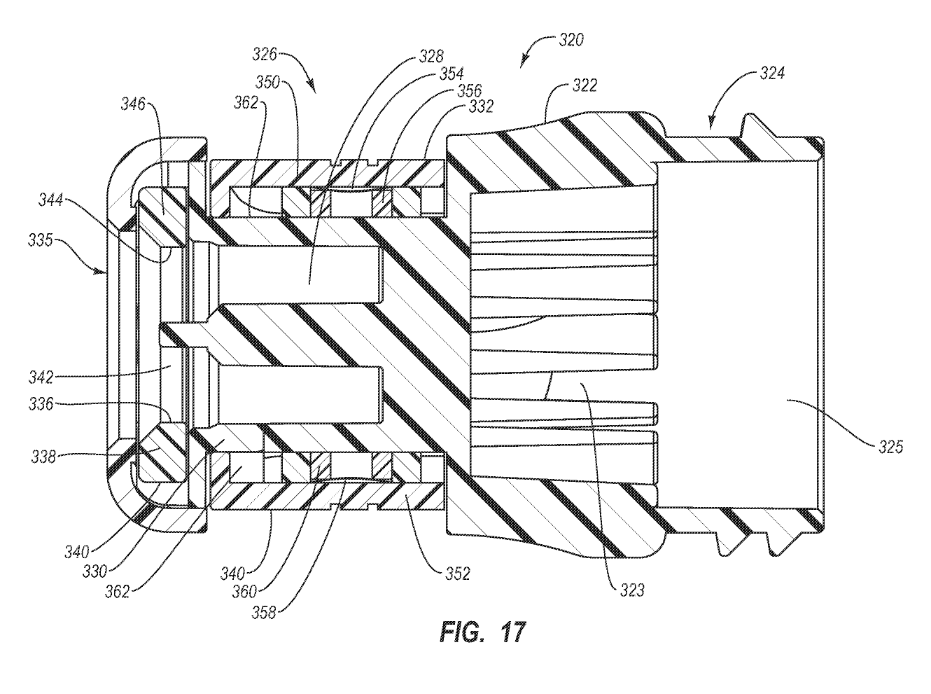

FIGS. 16 and 17 are cross sections of an alternate configuration of an inter-connector 320 similar to the inter-connector 238 of FIGS. 11 and 13. The inter-connector 320 has a base 322 with a first port 324 having a first port channel 325 to transmit liquids there through to the base channel 323 and a second port 326. The second port 326 is formed to be a female coupling member having a second port channel 328 in an internal conduit 330 having latching structure positioned to move between a latching position and an unlatching position. Specifically, a first button 332 has a first arm 334 attached thereto to extend around the aperture 335. The first arm 334 has a first lip 336 at or part of the distal end 338. The first lip 336 and the first button 332 operate substantially as the first button 266 and first arm 270 of FIGS. 11 and 13. A second button 340 has a second arm 342 connected to extend around the aperture 335 and sized to form a second lip 344 at the distal end 346 similar to the second button 268 and second arm 284 of FIGS. 11 and 13. The first arm 334 and the second arm 342 both move on the plate 348. The biasing means shown in FIG. 16 includes a first silicon spring 350 and a second silicon spring 352 with a first additional resilient member 354 positioned to interact against the ribs 356 affixed to the exterior surface 362 of the internal conduit 330. Similarly, the biasing means includes a second resilient member 358 positioned for contact by rib 360 mounted to the exterior surface 362 of the internal conduit 330. Upon movement of the first button 332 and the second button 340 from their at rest or first positions shown in FIG. 16 to their second positions shown in FIG. 17, the corresponding first lip 336 and the second lip 344 that move from extending into the aperture 335 to removal from the aperture 335 so that a male member like male member 116 (FIG. 8) can be inserted into and locked in place in the first position as shown in FIG. 16 and removed in the unlocked position shown in FIG. 17.

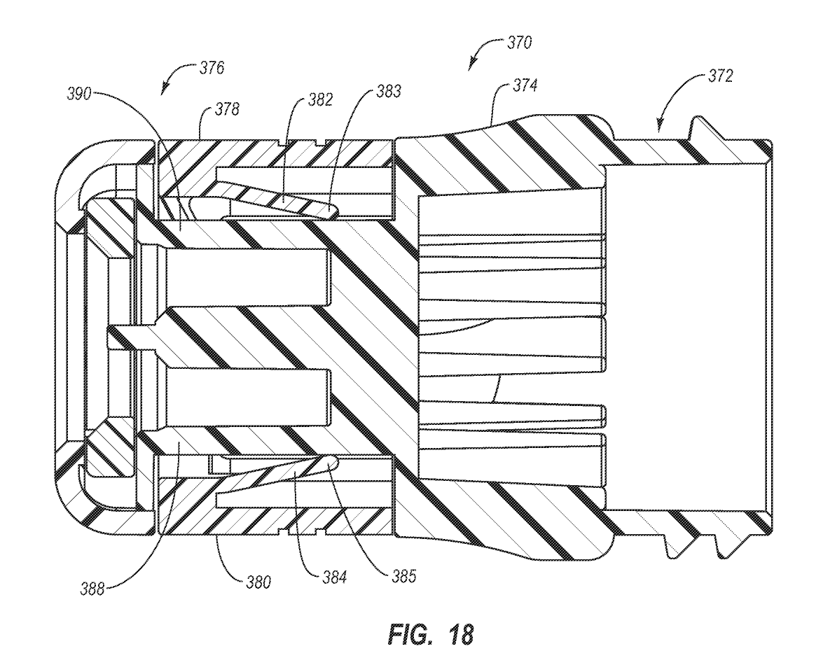

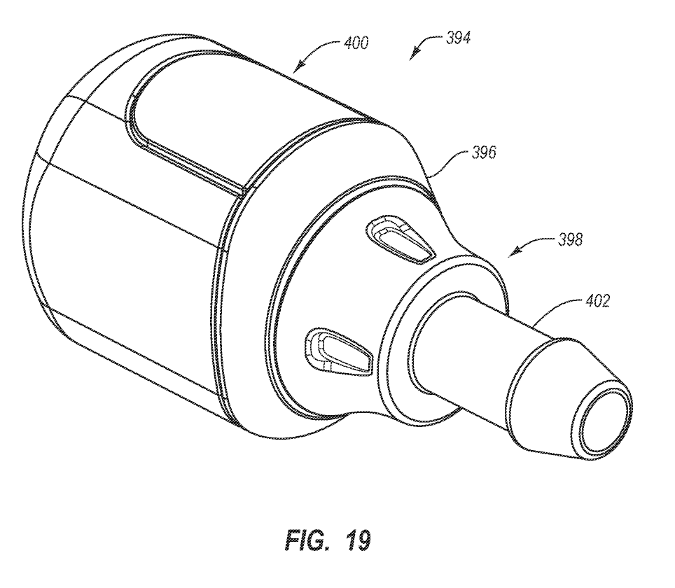

Another alternate configuration of an inter-connector 370 is shown in FIG. 18 having a first port 372, a base 374 and a second port 376 arranged like the inter connector 320 of FIGS. 16 and 17. The first button 378 and second button 380 are each formed with a plastic arm or first lever 382 and second lever 384 respectively. The first lever 382 has a distal end 383 in contact with the exterior surface 388 of the inner conduit 390. The second lever 384 has a distal end 385 that also is in contact with the exterior surface of the inner conduit 390. As the first button 378 and the second button 380 are pushed inwardly 386, the first lever 382 and the second lever 384 bend or elastically deform and function as leaf spring urging the first button 378 and the second button 380 from their second or depressed positions back to their respective first or at rest positions. In turn, it can be seen that the arm and lip configuration of FIG. 18 is essential the same as shown in FIGS. 16 and 17. In turn, the latching structure of FIG. 18 is moved between the first or latched position and a second an unlatched position as the buttons 378 and 380 move between their at rest and depressed positions. The buttons 378 and 380 are sized for operation by the fingers of a user.

An alternate form of inter-connector 394 in FIG. 19 has a base 396 with a first port 398 and a second port 400 attached thereto. The second port 400 may be in the form of those described in connection with FIGS. 11, 13 and 16-18 so that liquids may pass there through and so that the second port may function as female coupling member for connection with a male member of a connector like male member 116 (FIG. 8). The first port 398 is here shown in the shape of a barbed connector 402. The barbed connector 402 extends into a housing 404 that has a plurality of notches formed there about with only notches 406 and 408 visible. The notches provide a means for a spin welding machine to attach and to spin the first port 398 against the base 396 to effect a spin welding connection between the housing 404 and the base 396. It should be understood that the lieu of the barbed connector 402, the first port 398 may have a male threaded structure, a female threaded structure, a tube, a male member comparable to male member 116, a bayonet connector and any other structure to effect connection to a hydration system or to accessories for use with hydration systems.

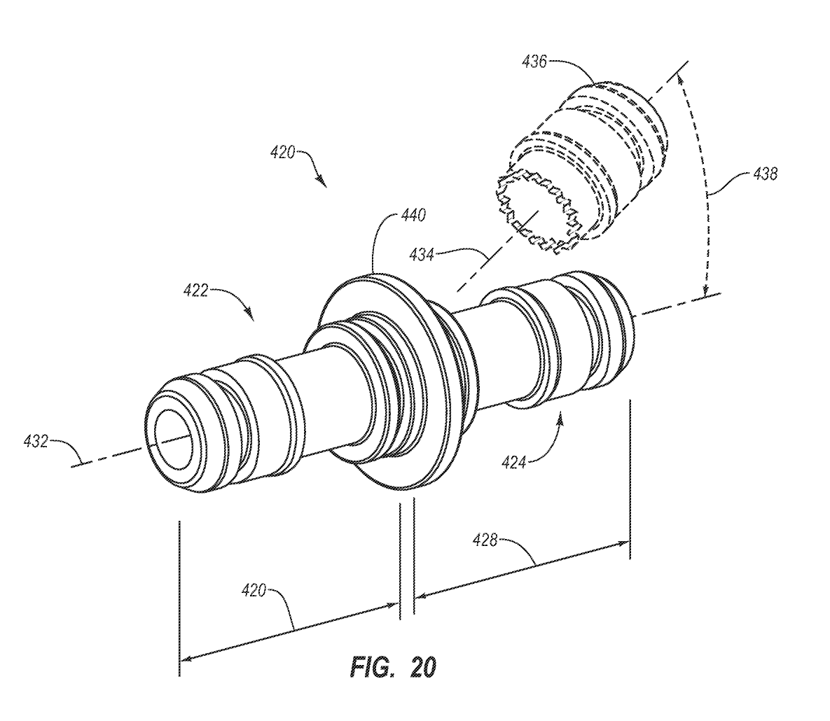

Turning now to FIG. 20, a quick connect connector 420 is shown having a first end 422 in the form of a male connector comparable to male member 116 of FIG. 8 and a second end 424 in the form of a male connector comparable to male member 116 of FIG. 8. One or two spacers like spacer 126 of FIG. 8 may be used to vary the length 426 of the first end 422 and the length 428 of the second end 424 between the first length and the second length as discussed with reference to FIG. 8. Notably, the first end 422 and the second end 424 each have a channel like channel 430 and are shown in axial alignment along axis 432. Alternately, the second end 424 may be formed to be at an angle so that the axis 434 of an alternate second end 436 is at an angle 438 to the axis 432. The angle 438 may vary from 0 to any desired angle up to about 170 degrees. In most applications, the angle will vary from about 15 degrees to about 90 degrees. The abutment member 440 can be made to vary in size to form the desired angle 438.

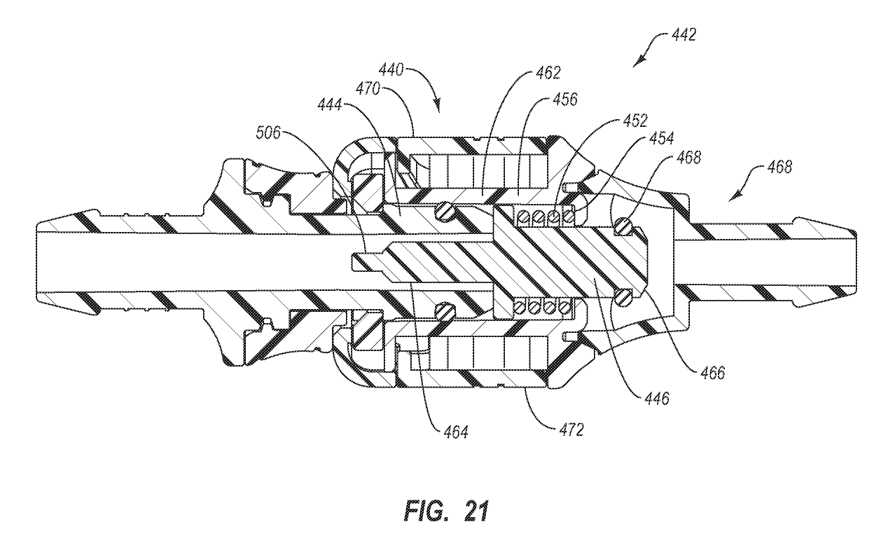

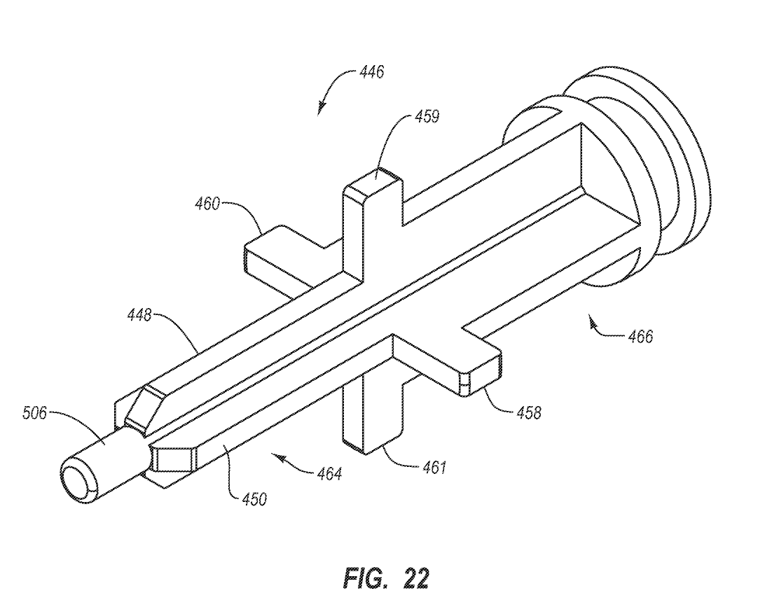

In FIG. 21, a female coupling member 440 of an inter-connector 442 is shown with a male member 444 of a quick connect comparable to that of FIG. 8 inserted therein to effect a fluid connection. The female coupling member 440 or second port is configured to include a spring loaded valve that is closed when the male member 444 is removed and that is open when the male member 444 is inserted as shown. The female coupling member 440 has a bobbin 446 comparable to that seen in FIG. 22. The bobbin 446 has intersecting walls 448 and 450 in the form of an “X”. A spring 452 is shown abutting the bottom 454 of the internal conduit 456 and abutting spring stops 458, 459, 460 and 461. As the male member 444 is inserted into the second port channel 462 the upper portion 464 of the bobbin 446 aligns the male member 444 as it comes to contact the spring stops 458-461. Continued movement of the male member 444 causes the bobbin 446 to move inwardly causing the lower portion 466 to move out of the bottom 454 allowing for the flow of liquids from or to the first port 468 through the bottom 454. The ‘X’ shape of the bobbin 446 allows fluid to flow there past in the second port channel 462. Upon operation of the buttons 470 and 472, the associated latching structure moves to its second or unlatching position as hereinbefore discussed so that the male member 444 may be removed. As the male member 444 is moving out of the second port channel 462, the spring 452 urges the bobbin 446 to move so that the bottom portion 466 with the ‘o’ ring 468 effects a seal with the bottom 454 and in effect closing the valve. Other components of the quick connect having the male member 444 and the inter-connector 442 have been discussed hereinbefore.

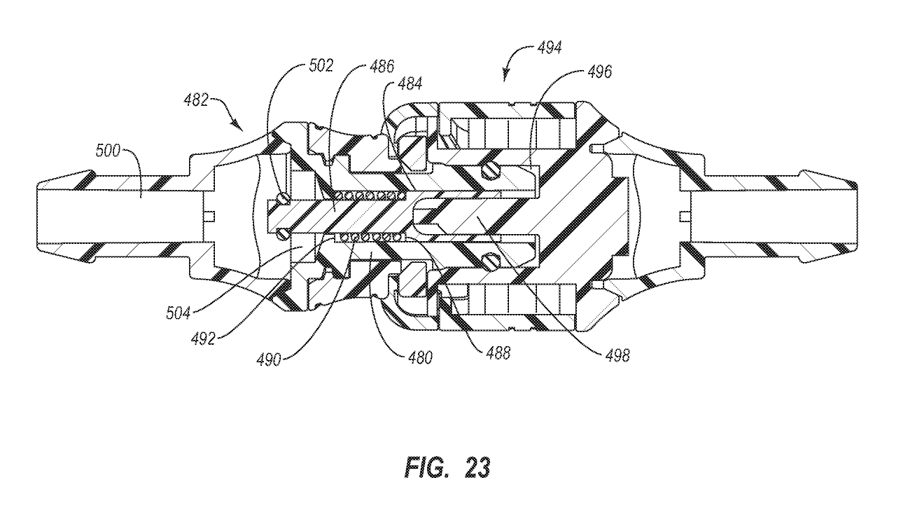

In FIG. 23, a male member 480 of a quick connect connector 482 is shown having a channel 484 formed with a bobbin 486 that has walls formed into an ‘X’ configuration like bobbin 446. Each of the walls of the bobbin 486 have an upper spring stop like spring stop 488. A spring 490 contacts the spring stops like spring stop 488 and a ledge 492. As the male member 480 is urged into the female coupling member 494 and, more particularly, the second port channel 496, its bobbin 498 contacts the bobbin 486 and urges it inwardly toward an open positions in which liquid can flow between second port channel 496 and the channel 500. As the male member 480 is removed from the female coupling member 494 and the second port channel 496, the spring 490 urges the bobbin 498 and, in turn, the ‘o’ ring 502 into a sealing relationship with the base 504. Thus, the male member 480 is movable between an open position when it is inserted into the female coupling member 494 and a closed position as it is removed from the female coupling member 494. Of course, the male member 480 as shown in FIG. 23 may be used with a female coupling member 440 of FIG. 21. That is, the upper end of the bobbin 446 has a center portion 506 that can be sized to operate the valve incorporated into the male member 480.

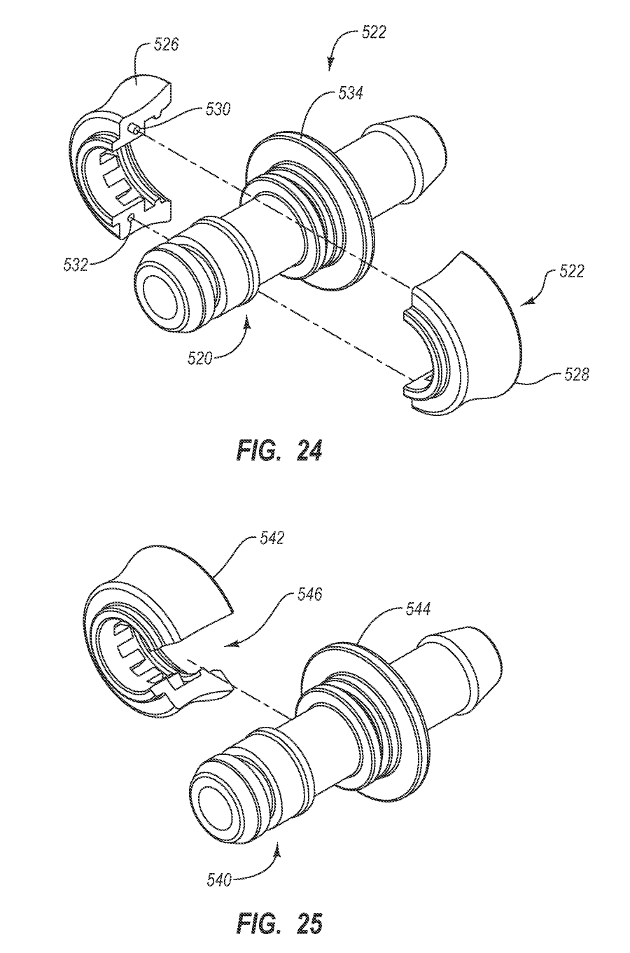

Returning to the FIG. 8, the spacer 126 is shown with an aperture 127 so that it can slide over the end 129 of the male member 116 and be lodged in abutment to the abutment member 128. In FIG. 24, a male member 520 of a quick connect connector 522 is shown with a spacer 524 sized like spacer 126 of FIG. 8 but split into a first half 526 and a second half 528. The first half 526 has an aperture 530 and a pin 532 to mate with and register with a corresponding pin and aperture not shown in the second half 528. In turn, the first half 526 and the second half 528 can be snapped together to from the complete spacer 522 in position about the male member 520 abutting the abutment member 534. Other forms of attaching the first half 526 and the second half 528 may be used including screws, a band about the outside, glue and the like.

In FIG. 25, the male member 540 is shown with a spacer 542 separate there from and in a position to attach to the male member 540 abutting the abutment member 544. The spacer 542 is similar in shape to the spacer 126 of FIG. 8 but with a gap or slot 546 so that the spacer 542 is in effect ‘C’ shaped. The spacer 542 is made of a resilient or elastic material like rubber or a suitable polymer so that the gap or slot 546 can be made wider or opened so that the spacer 542 can be positioned over the male member 540 and then return to its static condition about the male member 540. In effect, the male member 540 is snapped into place about the male member 540. It should be understood that the spacer 540 is here shown to be ‘C’ shaped. In FIG. 24 the spacer 522 is formed in halves. Other forms or shapes for the spacer 126, 522 and 540 may be used so long as the effect is to create a change in length of the male member from a first length to a second length.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced and deemed to be within their scope.

What is claimed is:

1. A spacer for use with a male member having a first end for connecting to or with a first female coupling member and for connecting to or with a second female coupling different in size from said first female coupling member, said spacer being positionable about or over said male member for changing the length of said male member between a first length for connecting to or with said first female coupling member with said spacer removed and a second length for connecting to or with said second female coupling member with said spacer installed on said male member.

2. The spacer of claim 1 wherein said spacer has an aperture formed therein sized to receive the first end there through.

3. The connector of claim 2 wherein said spacer has a first portion sized to fit partially about said first end and second portion sized to fit about said first end, said first portion and said second portion being sized and configured to mate together about said first end.

4. The connector of claim 1 wherein said spacer is a “C” shaped which is attachable to said male connector.

5. The spacer of claim 1 wherein said spacer is made of a resilient material.

6. The spacer of claim 1 wherein said spacer is made of a compressible material.

7. The spacer of claim 6 wherein said removable spacer is made of one of a rubber material or a polymer material.

8. The spacer of claim 7 wherein said spacer is formed to be a truncated cone.

9. The connector of claim 1 wherein said first end at said first length is sized to fit into a standard female coupling member of Camelbak Products, LLC and wherein said first end at said second length is sized to fit into the standard female coupling member of Colder Products Company.

10. A connector comprising:
a first end having a length and configured as a male connector for connecting with a female coupling member;
a second end configured for connection to a fluid system;
a center abutment member attached to and between said first end and said second end;
a channel formed in and extending through the first end and the center abutment to and through said second end for the flow of fluid there through; and
a removable spacer positionable on or about the first end adjacent said center abutment member to change the length of the first end between a first length with said spacer removed for connection to or with a first female coupling member sized to receive a male member of said first length and a second length with said spacer in position for connection to or with a second female coupling member sized to accept a male connecting member of said second length and not said first length.

11. The connector of claim 10 wherein said removable spacer has an aperture formed therein sized to receive said first end there through.

12. The connector of claim 11 wherein said removable spacer is formed of two separate portions configured to mate together about said first end.

13. The connector of claim 10 wherein said removable spacer is a “C” shaped and attachable to said first end proximate said center abutment.

14. The connector of claim 10 wherein said removable spacer is made of a resilient material.

15. The connector of claim 10 wherein said removable spacer is made of a compressible material.

16. The connector of claim 15 wherein said removable spacer means is made from one of polymer or rubber.

17. The connector of claim 10 wherein said removable spacer is shaped as a truncated cone.

18. The connector of claim 10 wherein said first end has a first axis and wherein said second end has a second axis and wherein said first axis and said second axis are coaxial.

19. The connector of claim 10 wherein said first end has a first axis and wherein said second end has a second axis and wherein said first axis and said second axis are at an angle.

20. The connector of claim 10 wherein said first end includes a valve that opens upon insertion of first end into said first and second female coupling member and closes upon removal from said first and second female coupling member.

21. The connector of claim 10 wherein said female coupling member includes a valve configured for operation from a closed position to an open position, and wherein said first end is configured to move said valve from its closed position to its open position upon insertion of said first end into said first female connector.

22. The connector of claim 10 wherein said first end at said first length is sized to fit into a standard female coupling member of Camelbak Products, LLC.

23. The connector of claim 22 wherein said first end at said second length is sized to fit into the standard female coupling member of Colder Products Company.

24. The connector of claim 10 wherein said second end is a barb connector.

25. The connector of claim 10 wherein said second end is a second male member for insertion into said female coupling member and wherein said removable spacer is positional on or about said second end adjacent said center abutment member to change the length of the second end between a first length with said spacer removed for connection to or with said first female coupling member sized to receive a male member of said first length and a second length with said spacer in position for connection to or with said second female coupling member sized to accept a male member of said second length and not said first length.

26. The connector of claim 10 wherein said female coupling member includes
a base having a channel formed therein for the movement of fluid there through;
a first port mechanically associated with said base and configured to communicate fluid there through and with said base;
a first port connector formed as part of said first port, said first port connector being configured for removable and sealing connection with a first external fluid communicating structure;
a second port mechanically associated with said base, said second port including a second port aperture sized to removably and sealingly receive said first end therein with said second spacer attached to be at said second length, said second port aperture being configured to communicate fluid there through between said first end and said base;
a second port connector associated with said second port for removably holding said first end member in said second port aperture, said second port connector including
first latch structure movable between a first latch position in which said first latch structure is urged into said second port aperture for engaging said first end when said first end is positioned in said second port aperture and a second latch position in which said first latch structure is urged away from said first end when said first end is positioned in said second port aperture,
second latch structure movable between a first latch position in which said second latch structure is urged into said second port aperture for engaging said first end when said first end is positioned in said second port aperture and a second latch position in which said second latch structure is urged away from said first end when said first end is positioned in said second port aperture,
a first button positioned for operation by a user and proximate said first latch structure to move said first latch structure between its first latch position and its second latch position,
a second button positioned for operation by a user and proximate said second latch structure to move said second latch structure between its first latch position and its second latch position, said second button being separate from and independently operable from said first button,
first biasing means positioned proximate said first button to urge said first button and said first latch structure toward its first latch position, and
second biasing means positioned proximate said second button to urge said second button and said second latch structure toward its first latch position.

27. The connector of claim 26 wherein said first latch structure includes a first lip positioned to engage said first end in said first latch position when said first end is in said second port aperture and wherein said second latch structure includes a second lip positioned to engage said first end when said first end is in said second port aperture.

28. A connecting device comprising:
a base having a channel formed therein for the movement of fluid there through;
an first port mechanically associated with said base and configured to communicate fluid there through and with said base;
an first port connector formed as part of said first port, said first port connector being configured for removable and sealing connection with a first external fluid communicating structure;
a second port mechanically associated with said base, said second port including a second port aperture sized to removably and sealingly receive a male member of a connector, said second port aperture being configured to communicate fluid there through between said first end and said base;
a second port connector associated with said second port for removably holding said first end member in said second port aperture, said second port connector including
first latch structure movable between a first latch position in which said first latch structure is urged into said second port aperture for engaging said first end when said first end is positioned in said second port aperture and a second latch position in which said first latch structure is urged away from said first end when said first end is positioned in said second port aperture,
second latch structure movable between a first latch position in which said second latch structure is urged into said second port aperture for engaging said first end when said first end is positioned in said second port aperture and a second latch position in which said second latch structure is urged away from said first end when said first end is positioned in said second port aperture,
a first button positioned for operation by a user and proximate said first latch structure to move said first latch structure between its first latch position and its second latch position,
a second button positioned for operation by a user and proximate said second latch structure to move said second latch structure between its first latch position and its second latch position, said second button being separate from and independently operable from said first button,
first biasing means positioned proximate said first button to urge said first button and said first latch structure toward its first latch position, and
second biasing means positioned proximate said second button to urge said second button and said second latch structure toward its first latch position.

29. The connector of claim 28 wherein said second port is cylindrical in shape with an exterior surface, and wherein said second port aperture is cylindrical in shape and sized to receive the first end therein, and wherein said first button and said second button are each spaced from each other about said exterior surface.

30. The connector of claim 29 further including a first fulcrum attached to said exterior surface, wherein said first button is positioned to rotate about said fulcrum with a first portion of said first button extending on one side of said first fulcrum and a second portion of said first button extending on the other side of said first fulcrum, wherein said first lever arm is attached to said first portion and wherein said first lever arm is sized to cause said first lip to move inwardly and outwardly between said first latch position and said second latch position as said second portion of said first button moves inward and outward toward and away from said exterior surface and wherein the first biasing means includes a first resilient lever and a second resilient lever spaced from said first resilient member, said first resilient lever and said second resilient lever both extending from said second portion of said first button toward said exterior surface, wherein said first resilient lever and said second resilient lever are both sized to contact said exterior surface and elastically deform about said exterior surface as said second portion of said first button moves inward and, in turn, urge said second portion of said first button outwardly from said exterior surface.

31. The connector of claim 29 wherein said first latch structure includes a first arm that extends around said second port aperture to position said first lip generally opposite said first button, and wherein said second latch structure includes a second arm that extends around said second port aperture to position said second lip generally opposite said second button, wherein said first biasing means is a first resilient member positioned between said first button and said exterior surface, said first biasing means being configured to urge said first button and said first lip toward its first latch position and said first biasing means being compressible upon movement of said first button toward said exterior surface by a user to urge said first latch structure including its first lip toward its second latch position away from any male connector in said second port aperture, and wherein said second biasing means is a second resilient member positioned between said second button and said exterior surface, said second biasing means being configured to urge said second button and said second lip toward its first latch position and said first biasing means being compressible upon movement of said second button toward said exterior surface by a user to urge said second latch structure including its second lip away from any male member in said second port.

32. The connector of claim 28 wherein said first port connector is a barb connector.

33. The connector of claim 28 wherein said first port connector is a threaded connector.

34. The connector of claim 28 wherein said male member includes a valve that opens upon insertion of said male member into said second port aperture and closes upon removal of said male member from said second port aperture.

35. The connector of claim 28 wherein said second port aperture includes a valve configured for operation from a closed position to an open position, and wherein said male member is configured to move said valve from its closed position to its open position upon insertion of said male member into said second port aperture.
